(19) United States
(12) Patent Application Publication
(10) Pub. No.: US 2015/0093489 A1
(43) Pub. Date: Apr. 2, 2015

(54) FOOD COMPOSITION COMPRISING A BLEND OF CELLULOSE ETHERS

(71) Applicant: HERCULES INCORPORATED, Wilmington (DE)

(72) Inventors: Jenna L. Derhammer, Lansdowne, PA (US); Mark E. Hines, Moorestown, NJ (US)

(21) Appl. No.: 14/496,510

(22) Filed: Sep. 25, 2014

Related U.S. Application Data
(60) Provisional application No. 61/883,228, filed on Sep. 27, 2013.

(51) Int. Cl. A21D 2/18

(52) U.S. Cl. CPC A21D 2/188
USPC 426/548; 426/555; 426/549

(57) ABSTRACT

The presently disclosed and claimed inventive concept(s) relates generally to a food composition for reducing fat comprising flour and a binder, and methods of making the composition and using the composition to reduce fat in fried and baked foods. The binder is a blend of two or more different water soluble cellulose ethers.

### CROSS REFERENCE TO RELATED APPLICATIONS

The present application claims the benefit under 35 U.S.C. 119 (e) of U.S. Provisional Patent Application Ser. No. 61/883,228, filed on Sep. 27, 2013, the entire content of which is hereby expressly incorporated herein by reference.

### BACKGROUND OF THE INVENTION

1. Field of the Disclosed and Claimed Inventive Concepts

The presently disclosed and/or claimed inventive process(es), procedure(s), method(s), product(s), result(s), and/or concept(s) (collectively hereinafter referred to as the “presently disclosed and/or claimed inventive concept(s)”) relates generally to a food composition for reducing fat comprising flour and a binder, and methods of making the composition and using the composition to reduce fat in fried and baked foods. The binder is a blend of two or more different water soluble cellulose ethers.

2. Background and Applicable Aspects of the Presently Disclosed and Claimed Inventive Concept(s)

Fried and baked foods are typically prepared from wheat flour and fats and contain, for example, from 5 to 30% fat such as shortening, which contains monoglycerides and diglycerides, and/or oil. The fat content provides a characteristic soft eating quality/texture and maintenance of shelf life for an extended time period.

Various fried and baked food products contain gums, combination of proteins and gums and other fat substitutes, and have been used in attempts to provide low fat products. However, such additives are expensive, are not suitable in foods which utilize high levels of fat for taste and texture, and may alter product appearance.

It has been known for a long time to incorporate cellulose ethers into food compositions, particularly into processed food compositions, to improve various properties, such as freeze thaw stability and/or texture or to improve firmness during manufacturing, machine handling or frying.

In view of the huge importance of reducing fat, it would be particularly desirable to find a new food composition for reducing fat which is effective for reducing fat in fried and baked foods with low cost.

### DETAILED DESCRIPTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular. Generally, nomenclatures utilized in connection with, and techniques of chemistry described herein are those well-known and commonly used in the art. Reactions and purification techniques are performed according to manufacturer's specifications or as commonly accomplished in the art or as described herein. The nomenclatures utilized in connection with, and the laboratory procedures and techniques of, analytical chemistry, synthetic organic chemistry, and medicinal and pharmaceutical chemistry described herein are those well-known and commonly used in the art. Standard techniques are used for chemical syntheses, chemical analysis, pharmaceutical preparation, formulation, and delivery, and treatment of patients.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, and/or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

The presently disclosed and claimed inventive concept(s) relates generally to a food composition for reducing fat. Specifically, the food composition comprises or consists of or consists essentially of flour and a binder, wherein the binder is a blend of two or more water soluble cellulose ethers.

Water-soluble cellulose ethers useful in the presently disclosed and claimed inventive concept can include, but are not limited to, methyl cellulose (MC), hydroxypropyl methyl cellulose (HPMC), and carboxymethyl cellulose (CMC).

Descriptions of suitable water-soluble cellulose ethers, which meet the criteria of the presently disclosed and claimed inventive as described herein, can be found in the following references: alkyl and hydroxyalkylalkylcellulose (Chapter 3), and hydroxypropylcaulose (Chapter 13) in Handbook of Water-Soluble Gums and Resins, ed. R, L. Davidson, pub. McGraw-Hill (1980); and hydroxypropyl methylcaulose (pp 670-71) and methylcellulose (pp 864-865) in The United States Pharmacopeia, (The National Formulary), (USP XXII, 1990). The entire contents of all of these are hereby expressly incorporated herein by references,

in one aspect of the presently disclosed and claimed inventive concept(s), a binder comprises or consists of or consists essentially of methyl cellulose and hydroxypropyl methyl cellulose. A methoxyl content of the binder can be in a range from about 3% to about 18% by weight. In one non-limiting embodiment, a methoxyl content is from about 4% to about 10% by weight. In another non-limiting embodiment, a methoxyl content is from about 6% to 7.2% by weight.

A hydroxypropyl content of the binder can be in a range from about 0.7% to about 3.6% by weight. In one non-limiting embodiment, a hydroxypropyl content is from about 1.4% to about 3.6% by weight. In another non-limiting embodiment, a hydroxypropyl content is from about 2.1% to 3.6% by weight.

In another aspect of the presently disclosed and claimed inventive concept(s), a binder comprises or consists of or consists essentially of methyl cellulose and carboxymethyl cellulose. A methoxyl content of the cellulose ethers can he in a range from about 2.5% and about 16% by weight. In one non-limiting embodiment, a methoxyl content of the cellulose ethers can be in a range from about 2.7% to about 10% by weight. In another embodiment, a methoxyl content of the cellulose ethers can be in a range from about 10% to about 15% by weight.

in yet another aspect of the presently disclosed and claimed inventive concept(s), a binder comprises or consists of or consists essentially of hydroxypropyl methyl cellulose and carboxymethyl cellulose. A methoxyl content of the cellulose ethers can be in a range from about 2.5 %and about 16% by weight. In one non-limiting embodiment, a methoxyl content of the cellulose ethers can be in a range from about 2.7% to about 10% by weight. In another embodiment, a methoxyl content of the cellulose ethers can be in a range from about 10% to about 15% by weight.

A hydroxypropyl content of the cellulose ethers can be in a range from about 2% to about 6% by weight. In one non-limiting embodiment, a hydroxypropyl content of the cellulose ethers can be in a range from about 2% to about 3.8% by weight.

Methyl cellulose for use in the presently disclosed and claimed inventive concept(s) has an average degree of substitution DS_{methyl} of from about 1.2 to about 2.0. one non-limiting embodiment, the average degree of substitution DS_{methyl} is from about 1.5 to about 1.9. In another non-limiting embodiment, the average degree of substitution DS_{methyl} is from about 1.7 to about 1.9.

Hydroxypropyl methyl cellulose for use in the presently disclosed and claimed inventive concept(s) has an average degree of substitution DS_{methyl} of from about 1.2 to about 2.0. In one non-limiting embodiment, the average degree of substitution DS_{methyl} is from about 1.3 to about 1.8. In another non-limiting embodiment, the average degree of substitution DS_{methyl} is from about 1.3 to about 1.5. A molar degree of substitution MS_{hydroxypropyl} of hydroxypropyl cellulose is from about 0.1 to about 0.25. In one non-limiting embodiment MS_{hydroxyoropyl} from about 0.15 to about 0.25. In another non-limiting embodiment MS_{hydroxypropyl} is from about 0.20 to about 0.23.

Carboxymethyl cellulose according to the presently disclosed and claimed inventive concept(s) has a degree of substitution of at least about 0.8 carboxymethyl group per glucose unit. In one non-limiting embodiment, a degree of substitution of carboxymethyl groups is at least about 0.9.

The water soluble cellulose ether has a weight average molecular weight of at least 400,000 Daltons. In one non-limiting embodiment, a weight average molecular weight is in a range from about 450,000 to about 1,500,000 Daltons. In another non-limiting embodiment, a weight average molecular weight is in orange from about 750,000 to about 1,200,000 Daltons.

A weight ratio of two cellulose ethers in a binder can be in a range from about 10/90 to about 90/10. In one non-limiting embodiment, a weight ratio is in a range from about 20/80 to 80/20. In another non-limiting embodiment, a weight ratio is in a range from about 30/70 to about 70/30, In yet another non-limiting embodiment, a weight ratio is in a range from about 40/60 to about 60/40.

The flour used in the food composition can include, but are not limited to, wheat flour, corn flour, rice flour, potato flour, tapioca flour, oat flour, rye flour, cornstarch, barley flour and all other types of synthetic flours. In one non-limiting embodiment, the flour is wheat flour. In another non-limiting embodiment, the flour is potato flour, which incorporates such materials as starch and soy protein isolate, with or without heat and/or steam treatment. The wheat flours consist of several types including hard red spring, hard red winter, soft red winter and white winter and spring. These flour types are distinguished by differences in gluten quality, water absorption and protein content. Protein in these flours can vary from about 7 percent to about 14 percent, with the soft wheat flours having protein contents at the lower end of that range and the hard winter wheat flours having protein contents at the upper end of that range. In one non-limiting embodiment, the wheat flour used is general-purpose wheat flour. The food composition of the presently disclosed and claimed inventive concept(s) typically comprises about 4 percent to about 40 percent by weight of flour. In one non-limiting embodiment, the food composition can comprise from about 5 percent to about 40 percent by weight of flour.

The food composition of the presently disclosed and claimed inventive concept(s) can be a dough composition or a batter composition. The dough composition can be a frozen dough composition. The dough composition in the presently disclosed and claimed inventive concept(s) can be used to make cookies, cakes, cake donuts, muffins, and other batter-type doughs such as brownies, biscuits, etc. The batter composition can be used to coat various food substrates for example, but not by way of limitation, chicken, fish, cheese, vegetables, etc.

The food composition of the presently disclosed and claimed inventive concept(s) can be a restructured food composition. The restructured foods can be restructured meat or vegetable foods such as croquettes and onion rings.

In one non-limiting embodiment, the presently disclosed and claimed inventive concept(s) provides a dry food composition comprising flour and a dry blend of cellulose ethers. The dry food composition can be a dry dough composition or a dry batter composition.

The food composition in the presently disclosed and claimed inventive concept(s) further comprises at least one seasoning. The seasonings can be selected from the group consisting of salt, pepper, garlic, onion, cumin, paprika, herbs, allspice, annatto, basil, cilantro, coriander, cumin, chili, dill, horseradish, mace, mustard, paprika, parsley, rosemary, sage, sesame, tarragon, thyme, tumeric, and wasabi.

A leavening agent can optionally used in the presently disclosed and claimed inventive concept(s). In one non-limiting embodiment, the leavening agent can be baking soda or baking powder. The amount of baking powder can be in a range of about 0.8% to about 1.2% by weight. The baking powder can be a mixture of at least one bicarbonate salt or carbonate salt, at least one acidifying agent and at least one separating agent. Sodium bicarbonate can be used with sodium diphosphate or disodium dihydrogen pyrophosphate with a starch as separating agent. These mixtures are directly available commercially with a fixed composition. The baking powder in the above mentioned specific range is of importance to induce a rapid steam formation.

The baking soda can be sodium, potassium, or ammonium bicarbonate, and/or a baking acid, preferably sodium aluminum phosphate, monocalcium phosphate, dicalcium phosphate or mixtures thereof. The selection of the leavening agent is within the knowledge of one skilled in the art. Form zero percent to about 2 percent, preferably from about 0.1 percent to about 2 percent of the food composition of the presently disclosed and claimed inventive concept(s) can be leavening agent.

The food composition can comprise sugar or a sugar substitute. The sugar can be selected from the group consisting of sucrose, high fructose corn syrup, maltose, sorbitol, maltodextrin, lactose, and mixtures thereof.

For the ease of understanding and to conform to usual practice in the art the sugars within this application are referred to by the names of their open chain forms (e.g. fructose and glucose) irrespective of their actual conformation which is in a polysaccharide molecule, of course, always the ring form. The 5-membered rings are known as furanoses and the 6-membered rings are known as pyranoses. For example, in the case of fructose units and glucose units within a polysaccharide their correct designation would be fructofuranose units and glucopyranose units, respectively, which terms are less common to describe the composition of a polysaccharide.

The amount of the sugar according to the presently disclosed and claimed inventive concept(s) is from about 16% to about 27% by weight.

The food composition of the presently disclosed and claimed inventive concept(s) further comprises a polysaccharide hydrocolloid other than cellulose ethers described previously. Typically, the food composition of the presently disclosed and claimed inventive concept(s) comprises about 0.005% to about 8% by weight of polysaccharide hydrocolloid. In one non-limiting embodiment, the food composition can comprise about 0.01% to about 8% by weight of polysaccharide hydrocolloid. In another non-limiting embodiment, the food composition can comprise about 0.05% to about 5% by weight of polysaccharide hydrocolloid. In yet another non-limiting embodiment, the food composition can comprise about 0.1% to about 3% by weight of polysaccharide hydrocolloid.

The term “polysaccharide hydrocolloid” as used in the presently disclosed and claimed inventive concept(s) can include one type of polysaccharide hydrocolloid as well as mixtures of different types of polysaccharide hydrocolloids, Hydrocolloids are well known to the person skilled in the art and polysaccharide hydrocolloids are polysaccharide-based compositions that form colloidal dispersions (also referred to as “colloidal solutions”) in water. Typically, hydrocolloids can include cellulose and derivatives, mannans, galactomannans, Arbinoxylans, β-D-glucans, Arabinogalactan, Pectins, Exudate gums, mucilage gums, Fructans, Alignates, Canagreenans, Agar, Xanthan gum, Pullulan, Gellan gum, Chitin, Chitosan, Gelatin, and etc.

Examples of the galactoamannans can include, but are not limited to, locust bean gum, senna gum, guar gum, tara gum and fenugreek gum.

Alginic acid is a linear copolymer of (1-4)-linked β-D-mannuronic acid (M-unit) and a-L-gluronic acid (G-unit) which units are linked together in different sequences or blocks. The monomers can appear in homopolymeric blocks of consecutive G-units (G-blocks), consecutive M-units (M-blocks), alternating M- and G-units (MG-blocks), or randomly organized blocks. Alginate is the salt of alginic acid and comprises the respective mannuronate and guluronate units. Typically, alginate is employed in the presently disclosed and claimed inventive concept(s), for example, sodium and/or calcium alginate. Alginic acid/alginate is extracted from seaweeds, such as giant kelp (Macrocystis pyrifera).

In addition to the alginate-based polysaccharide hydrocolloid the food composition may optionally contain a non-ionic and non-acidic polysaccharide hydrocolloid.

Polysaccharide hydrocolloids for use in the food composition are based on non-digestible polysaccharides. In one non-limiting embodiment, the polysaccharide hydrocolloids can be natural gums including, but not limiting to, vegetable gums (e.g. fenugreek gum, guar gum, tara gum, locust bean gum, konjac gum, and inulin), gums derived from algae (e.g. agarose which is the main component of agar), and gums derived from bacteria (e.g. curdlan).

Curdlan is mainly composed of -1,3-glucan which is a high molecular weight polymer of glucose and consists of -(1,3)-linked D-glucose units. It is produced by bacteria such as Alcaligenes faecalis var. myxogenes, Agrobacterium radiobacter or Agrobacterium biobar.

The shortenings that can be employed in the food composition of the presently disclosed and claimed inventive concept(s) are well-known to those skilled in the art of baking and include solid or plastic, as well as liquid or semi-fluid, glyceride shortenings derived from animal, vegetable fats and oils including synthetically prepare shortenings. These glycerides can contain saturated or unsaturated “long-chain” acyl radicals having from about 12 to about 22 carbon atoms such as laurcyl, lauroyleoyl, myristoyl, myristoleoyl, palmitoy, palmitoleoyl, stearoyl, oleoyl, linoleoyl, linolenoyl, arachidoyl, arachidonoyl, behenoyl, erucoyl, and the like and are generally obtained from edible oils and fats such as corn oil, cottonseed oils, soybean oil, coconut oil, rapeseed oil, peanut oil, olive oil, palm oil, palm kernel oil, sunflower seed oil, safflower oil, lard, and tallow.

Some preferred shortenings are butter, soybean-based shortenings or oils, hydrogenated soybean-based shortening or oil, corn oil, palm. oil, hydrogenated palm oil, lard and tallow oils. It is preferred that the shortening used in the presently disclosed and claimed inventive concept(s) be in fluid form, i.e., liquid at room temperature or melted, when added to the other ingredients. From about 10 percent to about 35 percent, preferably from about 15 percent to about 32 percent by weight of the food composition comprises shortening.

Prefera.bly, the shortening can contain an emulsifier which comprises from about 3 percent to about 30 percent of the shortening system. Suitable emulsifiers are lactylated mono- and diglycerides, propylene glycol monoesters, polyglycerol esters, sorbitan esters, diacetylated tartaric acid esters of mono- and diglycerides, citric acid esters of monoglycerides, stearoyl-2-lactylates, polysorbates, succinylated monoglycerides, acetylated monoglycerides, ethoxylated monoglycerides, lecithin, sucrose monoester, and mixtures thereof. Polyglycerol esters suitable for use in the presently disclosed and inventive concept(s) have an average of from about 2 to about 10 glycerol units and from 1 to 3 fatty acryl groups containing from about 14 to about 18 carbon atoms per glycerol moiety.

The food composition of the presently disclosed and claimed inventive concept(s) comprises a liquid component. From about 3 percent to about 15 percent by weight of the food composition, comprises the liquid component added either via fresh egg (e.g., egg yolk, egg white, or whole egg), water, or a fresh egg plus water mixture in a dough composition. When fresh egg is used as the liquid component, it is generally included at from about 10 percent to about 15 percent of the dough. When water is utilized as the liquid component it is generally included at from about 10 percent to about 15 percent of the dough. When water is utilized as the liquid component it is generally included at from about 3 percent to about 5 percent of the dough. At least 40% of a liquid component by weight of the food composition is included in a batter composition. Similarly, the liquid component can include fresh egg (e.g., egg yolk, egg white, or whole egg), water, or a fresh egg plus water mixture.

The “conventional additives” can also be included in the food composition, for example, but not by way of limitation, flavors, and flavor additives, colors, nutrients, antioxidants, and antimicrobial agents.

The flavor additives can be of a type that remains as whole pieces in the food composition. Such additives can include, but are not limited to, chocolate, peanut butter or butterscotch chips or chunks, fruit or fruit-flavored bits, such as blueberry, strawberry, or citrus flavored bits, or other fruit flavored bits, such as cherry, blackberry, apricot, raisin, date, or apple. Cereals may also be used, such as bran or oatmeal, nutmeats including the whole or chopped meat of any edible nut including walnuts, black walnuts, hickory nuts, hazel nuts, Brazil nuts, peanuts, macadamia nuts, pecans, almonds, cashews, coconut and the like. From zero percent to about 30 percent of the food composition can be such additives.

Other flavor additives may be incorporated into the food composition prior to baking or frying to add flavor, aroma and color to the final baked or fried foods. Examples include spices, such as cinnamon, mace, nutmeg, caraway, anise, allspice, poppy seed, coriander, ginger, cloves, fennel, and salt and. flavorings, such as banana, orange, lemon, mint or vanilla, at levels up to about 10 percent of the food composition. Honey or molasses may also be used in the presently disclosed and claimed inventive concept(s) at levels up to about 15 percent. Mixtures of these flavorings and whole piece components can be added to provide a variety of desirable products.

The presently disclosed and claimed inventive concept(s) further relates to a method of making dough by combining the dough composition of the presently disclosed and claimed inventive concept(s) with water. The dough can be baked to make various baked foods.

The presently disclosed and claimed inventive concept(s) also relates to a method of making a batter food by combining the batter composition of the presently disclosed and claimed inventive concept(s) with water. The batter foods can be frozen, deep fried or baked.

The following examples illustrate the presently disclosed and claimed inventive concept(s), parts and percentages being by weight, unless otherwise indicated. Each example is provided by way of explanation of the presently disclosed and claimed inventive concept(s), not limitation of the presently disclosed and claimed inventive concept(s). In fact, it will be apparent to those skilled in the art that various modifications and variations can be made in the presently disclosed and claimed inventive concept(s) without departing from the scope or spirit of the invention. For instance, features illustrated or described as part of one embodiment, can be used on another embodiment to yield a still further embodiment. Thus, it is intended that the presently disclosed and claimed inventive concept(s) covers such modifications and variations as come within the scope of the appended claims and their equivalents.

### EXAMPLES

### Example 1

### Wheat-Based Batter (MC/CMC)

234 g of wheat four, 7.8 g of baking powder, 14.3 g of salt and blends of methyl cellulose (Benecel™ MC, available from Ashland Inc.) and carboxymethyl cellulose (Blanose™ 9M31F, available from Ashland Inc.) with various weight ratios were mixed dry together in a Kitchen Aid mixer on low to form a dry mixture. Water was added slowly into the dry mixture for about 2 minutes to form a wheat-based batter. A Balsa wood dip ( 3/16″×1″×4″) was dipped into the batter up to 2″. The batter was then fried for about 4 minutes at about 175° C. and a batter coating was prepared. The coating sample was cut from the center and tested. The tested results are shown in Table 1.

TABLE 1

| Sample | | | | |
|---|---|---|---|---|
| No. | % OCH₃ | DS | MC/CMC, weight ratio | Fat Reduced*, % |
| 1 | 2.7-3.2 | 0.9 | 10/90 | 26.88 |
| 2 | 5.4-6.4 | 0.9 | 20/80 | 26.32 |
| 3 | 8.1-9.6 | 0.9 | 30/70 | 30.70 |
| 4 | 10.8-12.8 | 0.9 | 40/60 | 13.11 |
| 5 | 13.5-16 | 0.9 | 50/50 | 9.47 |
| 6 | 16.2-19.2 | 0.9 | 60/40 | 6.97 |
| 7 | 18.9-22.4 | 0.9 | 70/30 | 8.25 |
| 8 | 21.6-25.6 | 0.9 | 80/20 | 14.82 |
| 9 | 24.3-28.8 | 0.9 | 90/10 | 20.04 |

*Fat reduced compared to control sample without cellulose ether blends

### Example 2

### Wheat-Based Batter (MC/HPMC)

234 g of wheat four, 7.8 g of baking powder, 14.3 g of salt and blends of methyl cellulose (Benecel™ MC, available from Ashland Inc.) and hydroxypropyl methyl cellulose (Benecel™ HPMC, available from Ashland Inc.) with various weight ratios were mixed dry together in a Kitchen Aid mixer on low to form a dry mixture. Water was added slowly into the dry mixture for about 2 minutes to form a wheat-based batter. A Balsa wood dip ( 3/16″×1″×4″) was dipped into the batter up to 2″. The batter was then fried for about 4 minutes at about 175 ° C. and the better coating was prepared. The coating sample was cut from the center and tested. The tested results are shown in Table 2.

TABLE 2

| | | | MC/HPMC, | Fat |
|---|---|---|---|---|
| Sample No. | % OCH₃ | % POOH* | weight ratio | Reduced**, % |
| 10 | 20.7-24.8 | 6.3-10.8 | 10/90 | 63.52 |
| 11 | 21.4-25.6 | 5.6-9.6 | 20/80 | 52.85 |
| 12 | 22.1-26.4 | 4.9-8.4 | 30/70 | 52.71 |
| 13 | 22.8-27.2 | 4.2-7.2 | 40/60 | 62.11 |
| 14 | 23.5-28 | 3.5-6 | 50/50 | 33.35 |
| 15 | 24.2-28.8 | 2.8-4.8 | 60/40 | 40.69 |
| 16 | 24.9-29.6 | 2.1-3.6 | 70/30 | 27.22 |
| 17 | 25.6-30.4 | 1.4-2.4 | 80/20 | 37.42 |
| 18 | 26.3-31.2 | 0.7-1.2 | 90/10 | 15.01 |

*Hydroxypropyl
**Fat reduced compared to control sample without cellulose ether blends

### Example 3

### Wheat-Based Batter (HPMC/CMC=50/50)

234 g of wheat four, 7.8 g of baking powder, 14.3 g of salt and blends hydroxypropyl methyl cellulose (Benecel™ HPMC, available from Ashland Inc.) and carboxymethyl cellulose (Blanose™ 9M31F, available from Ashland Inc.) with the weight ratio of 50/50 were mixed dry together in a Kitchen Aid mixer on low to form a dry mixture. Water was added slowly into the dry mixture for about 2 minutes to form a wheat-based batter. A Balsa wood dip ( 3/16″×1″×4″) was dipped into the batter up to 2″. The batter was then fried for about 4 minutes at about 175 ° C. and a batter coating was prepared. The coating sample was cut from the center and tested. The tested results are shown in Table 3.

TABLE 3

| Sample No. | % OCH₃ | % POOH* | HPMC/CMC, weight ratio | DS | Fat Reduced**, % |
|---|---|---|---|---|---|
| 19 | 14-15 | 3.5-6 | 50/50 | 0.9 | 37.32 |
| 20 | 13.5-15 | 2-3.8 | 50/50 | 0.9 | 43.83 |
| 21 | 10-12 | 3.5-6 | 50/50 | 0.9 | 35.08 |

*Hydroxypropy
*Fat reduced compared to control sample without cellulose ether blends

### Example 4

### Wheat-Based Batter—(Blend Ratio=50/50)

234 g of wheat four, 7.8 g of baking powder, 14.3 g of salt and blends of various cellulose ethers with the weight ratio of 50/50 were mixed dry together in a Kitchen Aid mixer on low to form a dry mixture. Water was added slowly into the dry mixture for about 2 minutes to form a wheat-based batter. A Balsa wood dip ( 3/16″×1″×4″) was dipped into the batter up to 2″. The batter was then fried for about 4 minutes at about 175 ° C. and a batter coating was prepared. The coating sample was cut from the center and tested. The tested results are shown in Table 4.

TABLE 4

| Sample | | | % | | Fat |
|---|---|---|---|---|---|
| No. | Blend Composition | % OCH₃ | POOH* | DS | Reduced**, % |
| 22 | MC(A)—HPMC(E) | 27.5-31 | 3.5-6 | | 39.94 |
| 23 | MC(A)—HPMC(F) | 27-31 | 2-3.8 | | 43.12 |
| 24 | MC(A)—HPMC(K) | 23.5-28 | 3.5-6 | | 45.56 |
| 25 | MC(A)—CMC | 13.5-16 | 0 | 0.9 | 43.36 |
| 26 | HPMC(E)—CMC | 14-15 | 3.5-6 | 0.9 | 37.32 |
| 27 | HPMC(F)—CMC | 13.5-15 | 2-3.8 | 0.9 | 43.83 |
| 28 | HPMC(K)—CMC | 10-12 | 3.5-6 | 0.9 | 35.08 |

*Hydroxypropy
*Fat reduced compared to control sample without cellulose ether blends

### Example 5

### Potato Croquettes (Blend Ratio=50/50)

143 g of potato flakes, 6 g of salt and blends of various cellulose ethers with various weight ratios were mixed dry together in a bowl to get a dry mixture. Boiling water was added into the dry until it was smooth. Small smooth potato balls (about 20 grams for each ball) were made. The balls were placed into a plastic bag and frozen overnight. The ball was then fried for about 3 minutes at about 175° C. The fried balls were placed on a non-absorptive surface and tested. The tested results are shown in Table 5.

TABLE 5

| Sample | | Blend Weight | | | | Fat |
|---|---|---|---|---|---|---|
| No. | Blend Composition | Ratio | % OCH₃ | % POOH* | DS | Reduced**, % |
| 28 | MC(A) - HPMC(K) | 20/80 | 21.4-25.6 | 5.6-9.6 | | 26.33 |
| 29 | MC(A) - CMC | 20/80 | 5.4-6.4 | 0 | 0.9 | −3.94 |
| 30 | MC(A) - CMC | 30/70 | 8.1-9.6 | 0 | 0.9 | 0.28 |
| 31 | HPMC(K) -CMC | 20/80 | 4-4.8 | 1.4-2.4 | 0.9 | 53.15 |
| 32 | HPMC((K) -CMC | 30/70 | 6-7.2 | 2.1-3.6 | 0.9 | 60.32 |

*Hydroxypropyl
**Fat reduced compared to control sample without cellulose ether blends

### Example 6

### Potato Croquettes (HPMC/CMC=30/70)

143 g of potato flakes, 6 g of salt and a blend of HPMC and CMC with the weight ratio of 3/7 were mixed dry together in a bowl to get a dry mixture. Boiling water was added into the dry until it was smooth. Small smooth potato balls (about 20 grams for each ball) were made. The balls were placed into a plastic bag and frozen overnight. The ball was then fried for about 3 minutes at about 175° C. The fried balls were placed on a non-absorptive surface and tested. The tested results are shown in Table 6.

TABLE 6

| Sample No. | % OCH₃ | % POOH* | DS | Fat Reduced**, % |
|---|---|---|---|---|
| B | 6-7.2 | 2.1-3.6 | 0.9 | 43.70 |
| B1 | 6-7.2 | 2.1-3.6 | 0.6 | 36.38 |
| B2 | 6-7.2 | 2.1-3.6 | 0.7 | 28.12 |

*Hydroxypropy
**Fat reduced compared to control sample without cellulose ether blends

It is, of course, not possible to describe every conceivable combination of the components or methodologies for purpose of describing the disclosed information, but one of ordinary skill in the art can recognize that many further combinations and permutations of the disclosed information are possible. Accordingly, the disclosed information is intended to embrace all such alternations, modifications and variations that fall within the spirit and scope of the appended claims.

What is claimed is:

1. A food composition for reducing fat comprising flour and a binder, wherein the binder comprises methyl cellulose and hydroxypropyl methyl cellulose, a methoxyl content is in a range from about 6% to about 7.2% by weight, and a hydroxypropyl content is in a range from about 2.1% to about 3.6% by weight.

2. A food composition for reducing fat comprising flour and a binder, wherein the binder comprises hydroxypropyl methyl cellulose and carboxymethoxyl cellulose, a methoxyl content is in a range from about 21.4% to about 25.6% by weight and a hydroxypropyl content is in a range from about 5.6% to about 9.6% by weight.

3. A food composition for reducing fat comprising flour and a binder, wherein the binder comprises methyl cellulose and carboxymethoxyl cellulose, a methoxyl content is in a range from about 21.4% to about 25.6% by weight and a hydroxypropyl content is in a range from about 5.6% to about 9.6% by weight.

4. The food composition of claim 2, wherein the degree of substitution of the carboxymethyl cellulose is at least 0.8.

5. The food composition of claim 3, wherein the degree of substitution of the carboxymethyl cellulose is at least 0.8.

6. The food composition of claim 4, wherein the degree of substitution of the carboxymethyl cellulose is about 0.9.

7. The food composition of claim 5, wherein the degree of substitution of the carboxymethyl cellulose is about 0.9.

8. The food composition of claim 1 is a dough composition.

9. The food composition of claim 1 is a batter composition.

10. The food composition of claim 1, wherein the flour is at least one of wheat flour, corn flour, rice flour, potato flour, tapioca flour, soy flour, oat flour, and barley flour.

11. The food composition of claim 10, wherein the flour is wheat flour.

12. The food composition of claim 10, wherein the flour is potato flour.

13. The food composition of claim 1, further comprising at least one seasoning.

14. The food composition of claim 13, wherein the seasoning is selected from the group consisting of salt, pepper, garlic, onion, cumin, paprika, herbs, allspice, annatto, basil, cilantro, coriander, cumin, chili, dill, horseradish, mace, mustard, paprika, parsley, rosemary, sage, sesame, tarragon, thyme, tumeric, and wasabi.

15. The food composition of claim 1, further comprising a leavening agent.

16. The food composition of claim 15, wherein the leavening agent is baking soda or baking powder.

17. The food composition of claim 1, further comprising a sugar.

18. The food composition of claim 17, wherein the sugar is selected from the group consisting of sucrose, high fructose corn syrup, maltose, sorbitol, maltodextrin, lactose, and combinations thereof.

19. The food composition of claim 1, further comprising shortening or oil.
